(19) United States
(12) Patent Application Publication
(10) Pub. No.: US 2010/0007590 A1
(43) Pub. Date: Jan. 14, 2010

(54) METHOD FOR ARRANGING LIGHT EMITTING DIODE MODULE, DATA CONVERTING METHOD FOR DISPLAYING MOVING PICTURE BY USING LIGHT EMITTING DIODE MODULE AND DATA CONVERTING APPARATUS THEREFOR

(75) Inventors: Gyun Chae, Suwon-si (KR); Euibyoung Kang, Suwon-si (KR); Hoe-Kwang Choi, Anyang-si (KR)

Correspondence Address: HARNESS, DICKEY & PIERCE, P.L.C., P.O. BOX 828, BLOOMFIELD HILLS, MI, 48303, US

(73) Assignees: Yuang D&U Co., Ltd., Hwaseong-si (KR); Arotech Co., Ltd., Hwaseong-si (KR); Ledworks Co., Ltd., Hwaseong-si (KR)

(21) Appl. No.: 12/439,437

(22) PCT Filed: Feb. 14, 2007
(86) PCT No.: PCT/KR2007/000774

§ 371 Date: Feb. 27, 2009

(30) Foreign Application Priority Data
Aug. 28, 2006 (KR) 10-2006-0081472

(51) Int. Cl. G09G 3/34

(52) U.S. Cl. 345/84

(57) ABSTRACT

Disclosed is a method for arranging light emitting diode (LED) modules, a data converting method for displaying a moving picture by using the LED modules and a data converting apparatus therefor. The apparatus includes: a data storage module for storing the moving picture and the image data; and a data conversion module for converting the moving picture into images according to frames, arranging the plurality of LED modules by matching the plurality of LED modules to the image according to each frame, determining locations of the plurality of LED modules, extracting color coordinates of each central point of regions in which the plurality of LED modules have been arranged from the image according to each frame, and generating color coordinates according to the locations as the image data. Accordingly, when a moving picture or a flash is output by means of LED modules, the moving picture or flash can be converted into image data so that a fine and smooth image just like an actual moving picture or flash can be output.

### TECHNICAL FIELD

The present invention relates to a method for arranging light emitting diode (LED) modules, a data converting method for displaying a moving picture by using the LED modules and a data converting apparatus therefor. In more detail, the present invention relates to a method for converting a picture (hereinafter, inclusively designated as a “moving picture”) including an image according to at least one frame, such as a moving picture or flash, into image data used to output the moving picture through LED modules by using the LED modules, each of which contains a plurality of LEDs, in order to display the moving picture, a method for arranging the LED modules for the image, and a data converting apparatus therefor.

### BACKGROUND ART

In general, an electric sign or electric bulletin board is a system for displaying various kinds of information in the form of a visual still picture or moving picture. Such electric signs are widely used for commercial advertisement, for sports grounds, for multi-visions, for traffic signals, and for information and messages, and have different sizes and employ different application systems depending on the purpose, object and location to which the electric signs are applied. For example, the electric signs for commercial advertisement are generally used indoors or outdoors in a color or dual-color scheme. The electric signs for sports grounds are used for stadiums, race grounds, football grounds, baseball grounds, swimming pools, etc. The electric signs for multi-visions are used for conference halls, for small theaters, for horse racing relays, for on-vehicle applications, etc. The electric signs for traffic signals are used for railroads having station platforms, ticket gates, waiting rooms, passageways, etc., and are used for express highways, city roads and other roads having induction lamps.

Also, the electric signs are used as a stock-price Big Board or stock condition board for securities markets. In addition, the electric signs are used for airports in order to inform arrivals and departures, for factories in order to express environmental pollution states, for offices, for electric clocks, and for information and messages which allow press media to transfer red-hot news and allow government or local self-government to transfer public information or normal information.

Meanwhile, such electric signs are roughly classified into mobile-type electric signs which can be loaded on a truck, a container, etc. for various events, and block-type electric signs which can take the place of a show or a multi-cube. As a means or device for displaying these electric signs, electric bulbs have been widely used in the beginning, but then fluorescent lamps have been generally used due to the amount of electric power usage of the electric bulbs. However, since electric bulbs and fluorescent lamps have a limitation in reducing the sizes thereof, electric bulbs and fluorescent lamps are unsuitable to display an image. Thus, recently, cathode-ray tubes (CRTs) and Fluorescent Display Tubes (FDTs) have been widely used, but the CRTs and FDTs have a limitation in increasing the sizes thereof. Accordingly, currently, most of electric signs are implemented by means of LEDs. These electric signs are widely installed and used from a medium size to a large size, from a low resolution to a high resolution, from advertisement to information transmission, and from a cross roads where many vehicles pass to a plaza where many pedestrians pass.

In general, LEDs used for an electric sign are implemented as an LED module, which includes an LED array containing a plurality of LEDs connected with each other, a driving device for driving the LED array, and a control device for controlling the driving device. A conventional LED module is implemented to a degree to produce single color images, or to produce color transition in specified forms of limited kinds by using LEDs of three colors of red (R), green(G) and blue (B). Therefore, the conventional LED module has a problem in that only a still image or limited colors, or only a simple moving picture having a few frames can be outputted.

In order to implement full colors by using an LED module, the LED module must be driven to control the luminance of three-color LEDs in several steps. In this end, it is necessary to extract color information according to frames from a moving picture, to divide an image into multiple regions, before the LED module is arranged.

However, a technology for smoothly displaying a full-color moving picture by means of an LED module by extracting color information from the full-color moving picture and arranging the LED module has not been developed until now, so it has been required to develop such a technology.

### DISCLOSURE OF THE INVENTION

Therefore, the present invention has been made in view of the above-mentioned problems, and it is an object of the present invention to provide a method for converting a picture (hereinafter, inclusively designated as a “moving picture”) including an image according to at least one frame, such as a moving picture or flash, into image data used to output the moving picture through LED modules by using the LED modules, each of which contains a plurality of LEDs, in order to display the moving picture, method for arranging the LED modules for the image, and a data converting apparatus therefor.

Therefore, the present invention has been made in view of the above-mentioned problems, and it is an object of the present invention to provide a method for converting a picture (hereinafter, inclusively designated as a “moving picture”) including an image according to at least one frame, such as a moving picture or flash, into image data used to output the moving picture through LED modules by using the LED modules, each of which contains a plurality of LEDs, in order to display the moving picture, method for arranging the LED modules for the image, and a data converting apparatus therefor.

In order to achieve the above-mentioned object, there is provided an apparatus for converting a moving picture into image data in order to output the moving picture by means of a light emitting diode (LED) panel which includes a plurality of LED modules, the apparatus including: a data storage module for storing the moving picture and the image data; and a data conversion module for converting the moving picture into images according to frames, arranging the plurality of LED modules by matching the plurality of LED modules to the image according to each frame, determining locations of the plurality of LED modules, extracting color coordinates of each central point of regions in which the plurality of LED modules have been arranged from the image according to each frame, and generating color coordinates according to the locations as the image data.

According to another aspect of the present invention, there is provided a method for converting a moving picture into image data in order to output the moving picture by means of a light emitting diode (LED) panel which includes a plurality of LED modules, the method including the steps of: (a) converting the moving picture into images according to frames; (b) arranging the plurality of LED modules by matching the plurality of LED modules to the image according to each frame, and determining locations of the plurality of LED modules; (c) calculating each central point of regions in which the plurality of LED modules have been arranged for the image according to each frame; and (d) extracting color coordinates of said each central point from the image according to each frame, and generating color coordinates according to the locations as the image data.

According to still another aspect of the present invention, there is provided a method for arranging a plurality of LED modules for images according to frames in an apparatus which converts a moving picture into image data by converting the moving picture into the image according to each frame in order to output the moving picture by means of a light emitting diode (LED) panel including the LED modules, the method including the steps of: (a) generating an enlarged image according to each frame by enlarging a size of the image according to each frame to a size of the LED panel; (b) dividing the enlarged image according to each frame into division regions having sizes equal to sizes of the LED modules; and (c) arranging the plurality of LED modules in such a manner as to correspond to the division regions respectively.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a block diagram schematically illustrating the electrical configuration of a light emitting diode (LED) control system for displaying a moving picture by means of LED modules according to an exemplary embodiment of the present invention;

FIG. 2 is a flowchart illustrating a data converting method for displaying a moving picture by means of LED modules according to an exemplary embodiment of the present invention;

FIG. 3 is a flowchart illustrating a method for arranging LED modules according to an exemplary embodiment of the present invention; and

FIGS. 4A and 4D are views illustrating a procedure for arranging LED modules for each frame image according to an exemplary embodiment of the present invention.

### BEST MODE FOR CARRYING OUT THE INVENTION

Hereinafter, one exemplary embodiment of according to the present invention will be described with reference to the accompanying drawings. It is to be noted that the same elements are indicated with the same reference numerals throughout the drawings. In the following description of the embodiment of the present invention, a detailed description of known functions and configurations incorporated herein will be omitted when it may obscure the subject matter of the present invention.

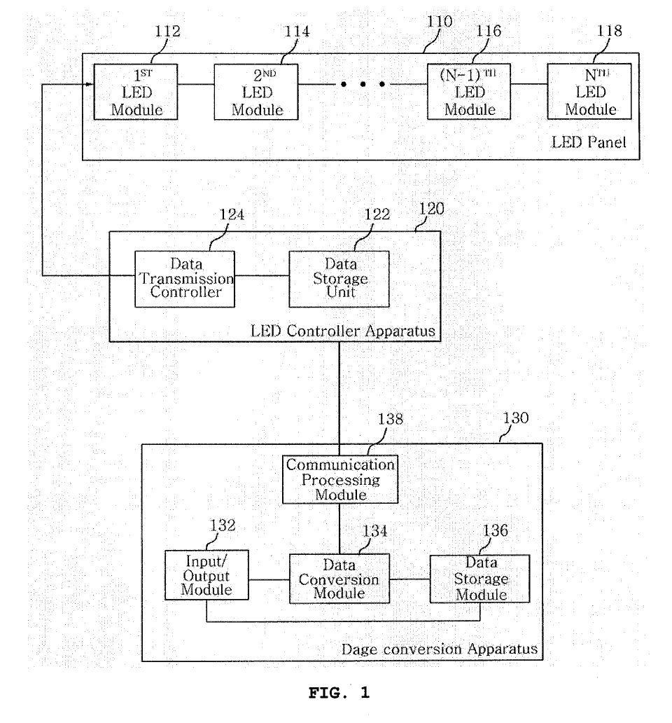

FIG. 1 is a block diagram schematically illustrating the electrical configuration of a light emitting diode (LED) control system for displaying a moving picture by means of LED modules according to an exemplary embodiment of the present invention.

The LED control system for displaying a moving picture by means of LED modules according to an exemplary embodiment of the present invention includes an LED panel 110, an LED control apparatus 120, and a data conversion apparatus 130.

The LED panel 110 includes a plurality of LED modules, that is, a first LED module 112, a second LED module 114, . . . , an (n-1)^{th} LED module 116, and an n^{th} LED module 118, and displays an image, a still picture, a moving picture, a flash, etc., by causing LEDs in each LED module to emit light.

The first LED module 112, second LED module 114, . . . , (n-1)^{th} LED module 116, and nth LED module 118 includes a plurality of LEDs, and drive the LEDs according to image data and control data transmitted from the LED control apparatus 120 so that the LEDs can emit light with color determined depending on the image data and control data.

The LED control apparatus 120 transmits image data and control data to each LED module 112, 114, 116 and 118 of the LED panel 110 so that the LED modules 112, 114, 116 and 118 can display an image, a still picture, a moving picture, flash, etc.

According to an exemplary embodiment of the present invention, the LED control apparatus 120 includes a data storage unit 122 and a data transmission controller 124, so as to store image data transmitted from the data conversion apparatus 130, and to transmit image data and control data to drive each LED module 112, 114, 116 and 118 to each LED module 112, 114, 116 and 118 according to a pre-stipulated signal transmission scheme.

The data storage unit 122 stores image data transmitted from the data conversion apparatus 130, and transmits the stored image data to the data transmission controller 124 when receiving a transmission request from the data transmission controller 124.

The data transmission controller 124 generates the control data according to a pre-stipulated signal transmission scheme, and transmits the control data and image data to each LED module 112, 114, 116 and 118. Herein, the pre-stipulated signal transmission scheme represents a signal transmission scheme for transmitting image data to each of the LED modules 112, 114, 116 and 118 connected in series so that the LED modules 112, 114, 116 and 118 can output a moving picture, and is used to generate control data.

Herein, the control data includes address data for identifying each LED module 112, 114, 116 and 118, address interval data for identifying an interval in which the address data is transmitted, image transmission data including image data and address data, and image interval data for identifying an interval during which the image transmission data is transmitted.

Therefore, in order to drive each LED module 112, 114, 116 and 118 to output a moving picture, the data transmission controller 124 first generates the aforementioned control data according to the pre-stipulated signal transmission scheme. Then, the data transmission controller 124 transmits address interval data to each LED module 112, 114, 116 and 118 so that each LED module 112, 114, 116 and 118 can receive address data in parallel from the data transmission controller 124, transmits address data in series to the LED modules 112, 114, 116 and 118 so that each LED module 112, 114, 116 and 118 can store its own address data, and transmits image interval data to each LED module 112, 114, 116 and 118 so that the LED modules 112, 114, 116 and 118 can receive image transmission data in parallel. Next, the data transmission controller 124 transmits address data and image data to each LED module 112, 114, 116 and 118 so that each LED module 112, 114, 116 and 118 can compare received address data with a pre-stored address data, and can drive LEDs so as to emit light according to image data only when the image data corresponds to its own image data.

The data conversion apparatus 130 includes an input/output module 132, a data conversion module 134 a data storage module 136 and a communication processing module 138, and converts a moving picture input, received or generated into image data which can be output by the LED modules 112, 114, 116 and 118.

The input/output module 132 includes an input means and an output means. The input means includes a keyboard, a mouse, a compact disk (CD), a universal serial bus (USB), etc. for receiving data or a command from the user and transmitting the data or command to the data conversion module 134. The output means includes a monitor, a speaker, etc. for outputting transmitted data trough a screen or other various means.

According to an exemplary embodiment of the present invention, the input/output module 132 receives the size of the LED panel 110 and the size of each LED module 112, 114, 116 and 118, and transfers the received size information to the data conversion module 134 or stores the received size information in the data storage module 136. Also, according to an exemplary embodiment of the present invention, the input/output module 132 may receive an arrangement direction and/or a region rate and store the received information in the data storage module 136.

The data conversion module 134 converts an image (hereinafter, inclusively designated as a “moving picture”) having at least one frame, such as a moving picture or flash, which has been generated or inputted/received through the input/output module 132 and then has been stored in the data storage module 136, into image data to be output by each LED module 112, 114, 116 and 118.

According to an exemplary embodiment of the present invention, the data conversion module 134 converts a moving picture stored in the data storage module 136 into a plurality of images according to frames, arranges the LED modules 112, 114, 116 and 118 of the LED panel 110 so as to correspond to each frame image, extracts the color coordinates of the central point of each region where each LED module is arranged for each frame image, generates image data from the color coordinates, stores the image data, and transmits the image data to the data storage unit 122 of the LED control apparatus 120 through the communication processing module 138 so as to store the image data in the data storage unit 122.

That is, since a moving picture is constructed with a constant number of frame images per second, the data conversion module 134 according to an exemplary embodiment of the present invention extracts images according to frames of a moving picture and converts the extracted images into each frame image in order to control the LED modules 112, 114, 116 and 118 according to each frame constituting the moving picture.

Also, in arranging a plurality of LED modules for each frame image, the data conversion module 134 according to an exemplary embodiment of the present invention receives the size of each frame image through the input/output module 132 and generates each enlarged frame image by converting each frame image so as to have the same size as that of the LED panel 110 pre-stored in the data storage module 136, or receives each enlarged frame image through the input/output module 132. Then, the data conversion module 134 divides the image into division regions according to an LED module size pre-stored in the data storage module 136, matches each LED module to each division region, thereby arranging the LED modules 112, 114, 116 and 118 of the LED panel 110 for each frame image.

Also, after arranging the LED modules 112, 114, 116 and 118 for each frame image, as described above, the data conversion module 134 according to an exemplary embodiment of the present invention determines the number and locations of LED modules which must be driven in order to output a moving picture, and may output information about the determined number and locations of LED modules through the input/output module 132 according to necessity.

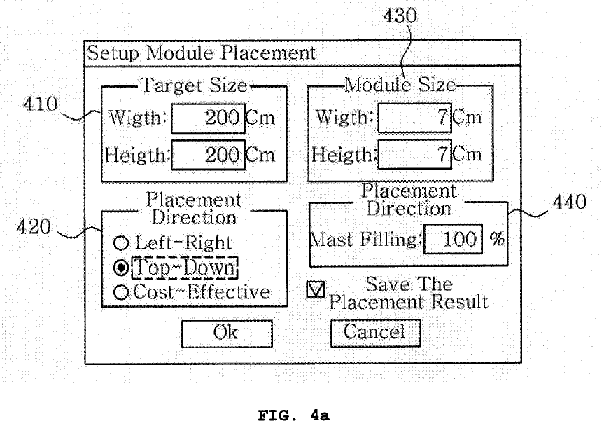

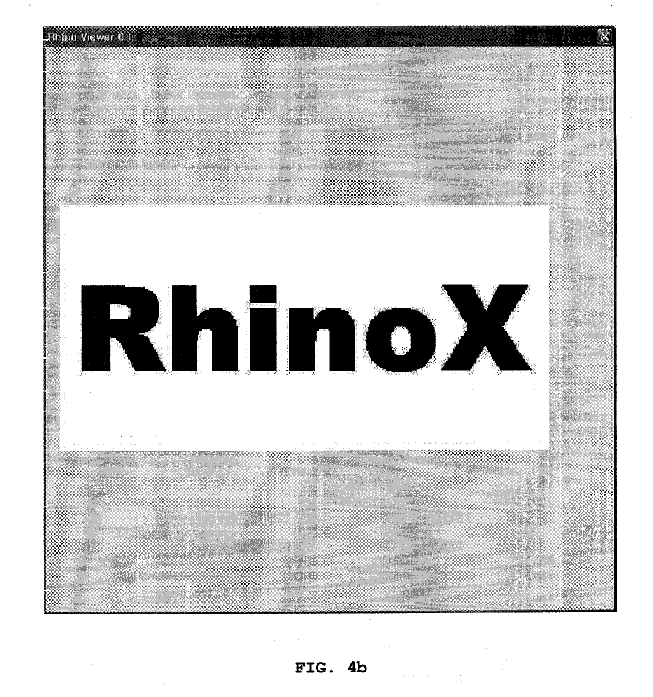

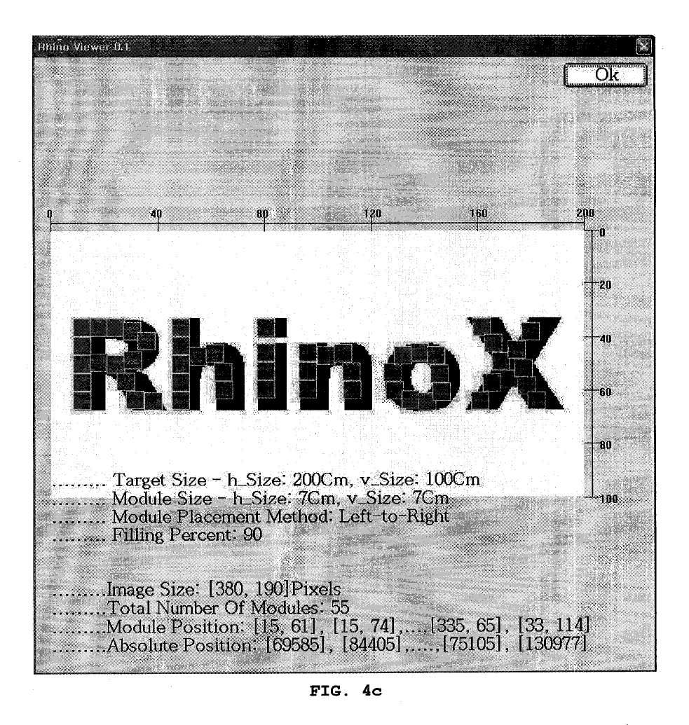

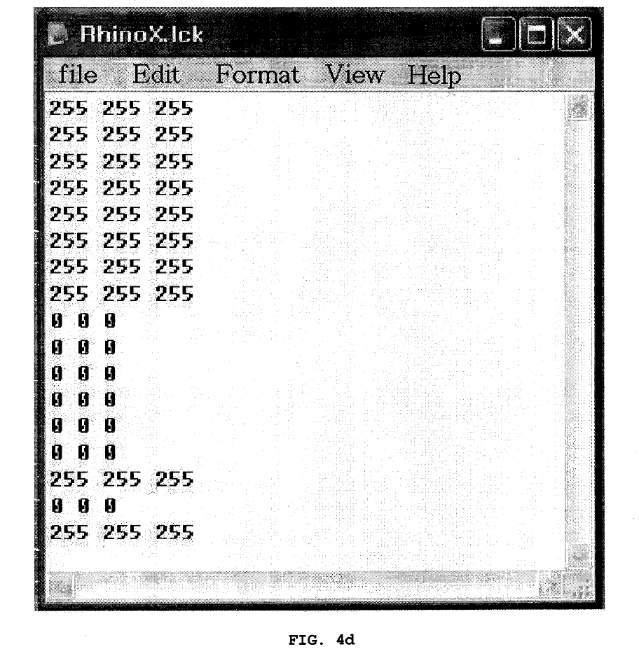

A method of allowing the data conversion module 134 to convert a moving picture into images according to frames and to arrange LED modules for each frame image according to an exemplary embodiment of the present invention will be described in detail later with reference to FIGS. 4A to 4D.

Also, when receiving data or a command from the input/output module 132, the data conversion module 134 according to an exemplary embodiment of the present invention may adjust the number or the arranged state of LED modules 112, 114, 116 and 118 which has been arranged as described above depending on the received data or command.

That is, as described above, each LED module 112, 114, 116 and 118 arranged for each frame image takes charge of a predetermined portion of the area for each image when a moving picture is output through the LED panel 110. In this case, in order to display a moving picture in more detail, the number of the LED modules 112, 114, 116 and 118 may increase or the arrangement interval between the LED modules may be made narrow. Also, when it is intended to output a letter signboard for advertisement or the like which does not require the display of a detailed image, the number of the LED modules 112, 114, 116 and 118 may decrease or the arrangement interval between the LED modules may be widened.

Also, the data conversion module 134 according to an exemplary embodiment of the present invention may convert only a predetermined part of a moving picture, as well as all the moving picture.

The data storage module 136 stores received data. The data storage module 136 according to an exemplary embodiment of the present invention may store the size of the LED panel 110 and the size of each LED module 112, 114, 116 and 118, which have been received from the input/output module 132, store a generated or input moving picture, and store image data converted from a moving picture.

The communication processing module 138 performs wired/wireless communication with an external apparatus by performing wired communication, such as serial communication, parallel communication, universal serial bus communication, etc., or by performing wireless communication, such as Bluetooth, Infrared Data Association (IrDA), etc.

The communication processing module 138 according to an exemplary embodiment of the present invention transmits image data generated by the data conversion module 134 to the data storage unit 122 of the LED control apparatus 120 so as to store the image data in the data storage unit 122.

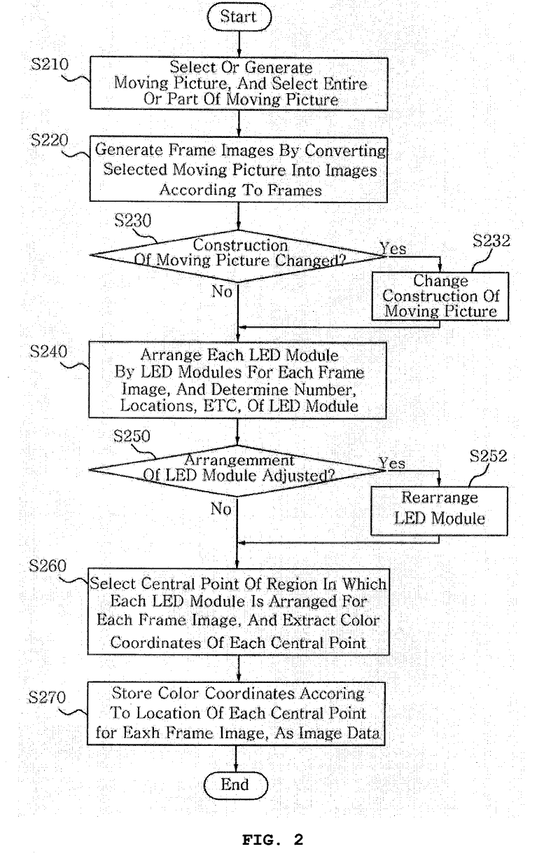

FIG. 2 is a flowchart illustrating the data converting method for displaying a moving picture by means of LED modules according to an exemplary embodiment of the present invention.

The data conversion module 134 selects all or a part of a moving picture stored in the data storage module 136 or all or a part of a moving picture input from the input/output module 132 (step 210), and converts the selected moving picture into images having a predetermined form according to each frame, thereby generating a plurality of images according to frames (step 220). In this case, the data conversion module 134 may display a procedure of generating a plurality of images according to frames from a moving picture through the input/output module 132 on a screen.

Then, the data conversion module 134 determines if it is necessary to change the configuration of the moving picture (step 230). When it is determined that it is necessary to change the configuration of the moving picture, the data conversion module 134 changes the configuration of the moving picture, that is, changes a reproduction time period, etc. (step 232), and performs a procedure of generating a plurality of images according to frames from the changed moving picture. In this case, the data conversion module 134 may determine that it is necessary to change the configuration of the moving picture either according to a predetermined procedure or when having received a command from the input/output module 132.

In contrast, when it is unnecessary to change the configuration of the moving picture, the data conversion module 134 arranges each LED module 112, 114, 116 and 118 by matching the LED modules 112, 114, 116 and 118 to each generated frame image, and determines the number, locations, etc. of LED modules which must be driven upon outputting the moving picture from among the arranged LED modules 112, 114, 116 and 118 (step 240).

Then, the data conversion module 134, which has arranged the LED modules 112, 114, 116 and 118 for each frame image, determines if it is necessary to adjust the arranged state of the LED modules (step 250). When it is determined that it is necessary to adjust the arrangement of the LED modules, the data conversion module 134 rearranges the LED modules (step 252), and again determines the number, locations, etc. of required LED modules in the rearranged state. That is, the data conversion module 134 arranges the LED modules 112, 114, 116 and 118 for each frame image; outputs a resultant arrangement through the input/output module 132 on a screen; receives information about if it is necessary to rearrange the LED modules, through the input/output module 132 from the user; rearranges each LED module 112, 114, 116 and 118 according to the number of the LED modules and intervals therebetween, which has been appointed by a command to rearrange the LED modules, when receiving the command; and again determines the number and the locations of the LED modules.

After arranging or rearranging each LED module 112, 114, 116 and 118, the data conversion module 134 selects each central point of regions where the LED modules 112, 114, 116 and 118 have been arranged for each frame image, and extracts the color coordinates of each central point (step 260).

That is, when the LED modules 112, 114, 116 and 118 have been arranged for each frame image, each LED module 112, 114, 116 and 118 takes charge of a predetermined region of each frame image. Therefore, the data conversion module 134 finds the central points of regions, each of which is assigned to each LED module 112, 114, 116 and 118, in each frame image, and extracts the color coordinates of each central point. In this case, the color coordinates extracted from each central point corresponds to color coordinates for three colors of red (R), green (G) and blue (B). The color coordinates extracted in such a manner are used for LED arrays of red, green and blue included in each LED module 112, 114, 116 and 118 to emit light.

Therefore, upon outputting a moving picture in a state in which the color coordinates have been extracted from the central point of each region assigned to each LED module 112, 114, 116 and 118 in each frame image and have been stored, when corresponding color coordinates are transferred to each LED module 112, 114, 116 and 118 so that each LED module 112, 114, 116 and 118 can emit light with red, green and blue colors appointed by color coordinates for each frame image, it is possible to display full colors expressible in the moving picture with smoothness by means of the LED panel 110.

The data conversion module 134, which has extracted the color coordinates from each central point, stores the color coordinates of each central point for each frame image as image data (step 270). In this case, the image data are stored together with information about the location of each corresponding central point so that it is possible to identify LED modules 112, 114, 116 and 118 required to be driven upon outputting the moving picture.

Herein, color coordinates of each central point can easily be extracted from each frame image, by utilizing a general image editing tool. That is, an image editing tool, such as Photoshop, can extract color coordinates of red, green and blue pixel by pixel from an image, which function can be used to extract color coordinates of each central point.

Through such a procedure, the data conversion apparatus 130 can convert a moving picture into image data which can be output by the LED modules 112, 114, 116 and 118.

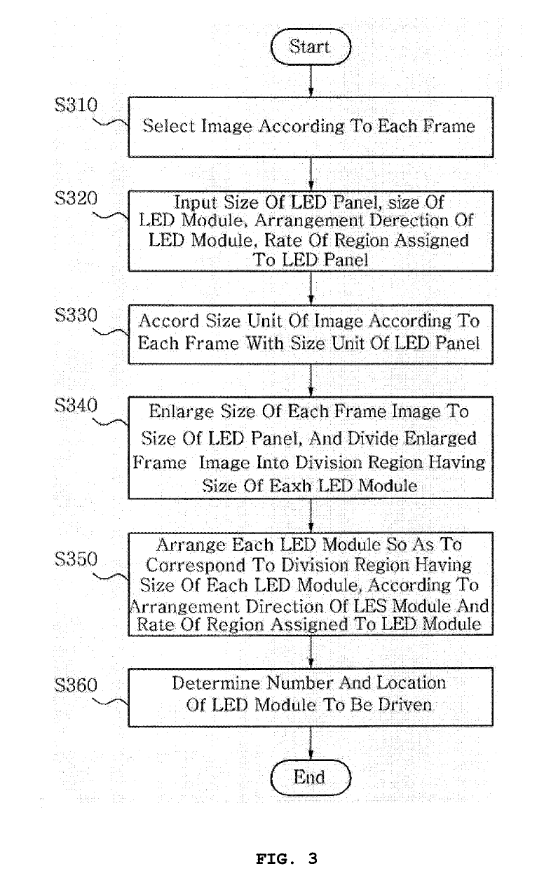

Hereinafter, a method of allowing the data conversion module 134 to arrange the LED modules 112, 114, 116 and 118 for each frame image, as shown in step 240, will be described in detail with reference to FIG. 3.

FIG. 3 is a flowchart illustrating a method for arranging LED modules according to an exemplary embodiment of the present invention.

The number of frame images generated by extracting images according to frames from a moving picture is the same as the number of frames constituting the moving picture. Therefore, the data conversion module 134 generates a plurality of frame images as many as frames in step 220. Therefore, the data conversion module 134 arranges the LED modules 112, 114, 116 and 118 for each frame image.

Although the following description will be given about a procedure of arranging the LED modules 112, 114, 116 and 118 for one frame image, the data conversion module 134 can arrange the LED modules 112, 114, 116 and 118 for every frame image by repeatedly performing the procedure.

The data conversion module 134 selects one frame image from among a plurality of frame images (step 310), and either reads the size of the LED panel 110 and the size of each LED module 112, 114, 116 and 118, which has been stored in the data storage module 136, or receives the size of the LED panel 110 and the size of each LED module 112, 114, 116 and 118 from the input/output module 132 (step 320). In this case, the data conversion module 134 can obtain arrangement direction information about an arrangement direction of LED modules and region rate information about a rate of a region assigned to each LED module, either by receiving the information through the input/output module 132 or by reading the information stored in the data storage module 136.

The data conversion module 134, which has obtained information about the size of the LED panel 110 and the size of each LED module 112, 114, 116 and 118 from the input/output module 132, generates an enlarged frame image by enlarging the size of the selected frame image to the size of the LED panel 110, and divides the enlarged frame image into regions each of which has the same size as each LED module 112, 114, 116 and 118, thereby generating division regions (step 340).

In this case, when enlarging the size of the frame image to the size of the LED panel 110, the data conversion module 134 may accord the size unit of the frame image with the size unit of the LED panel 110 (step 330). That is, generally, an image is expressed in units of pixels, and pixels may have different absolute sizes depending on screen resolutions. Therefore, it is preferred to accord the unit of pixels with the unit of the LED panel 110 by converting pixels into a unit of millimeter, centimeter, meter or inch based on a predetermined resolution so as to have the same size unit as the LED panel 110 (which is generally expressed in a unit of centimeter) before a frame image is converted to an enlarged frame image.

After dividing the enlarged frame image into division regions, each of which has the same size as that assigned to each LED module 112, 114, 116 and 118, the data conversion module 134 arranges each LED module 112, 114, 116 and 118 for the enlarged frame image by matching the division regions to each LED module 112, 114, 116 and 118 (step 350). In this case, if the data conversion module 134 has received or stored the arrangement direction information and/or region rate information in step 320, the data conversion module 134 may arrange the LED modules 112, 114, 116 and 118 according to the arrangement direction and/or the region rate.

The data conversion module 134, which has arranged the LED modules 112, 114, 116 and 118 for the enlarged frame image, determines the number of locations of LED modules which must be driven upon outputting the moving picture (step 360).

Through the aforementioned procedure, the data conversion module 134 arranges the LED modules 112, 114, 116 and 118 for each frame image.

FIGS. 4A and 4D are views illustrating a procedure for arranging LED modules for each frame image according to an exemplary embodiment of the present invention.

FIG. 4A is a view illustrating a procedure of inputting the sizes of a LED panel and an LED module according to an exemplary embodiment of the present invention.

When arranging the LED modules 112, 114, 116 and 118 for each frame image after converting a moving picture into images according to frames, the data conversion module 134 receives the size of an LED panel through “Target Size” 410 and receives the size of an LED module through “Module Size” 420, as shown in FIG. 4A. Also, according to necessity, the data conversion module 134 may receive arrangement direction information through “Placement Direction” 430 and receive region rate information through “Placement Decision ” 440, and then may arrange the LED modules 112, 114, 116 and 118 for each frame image according to the received arrangement direction information and region rate information.

Herein, the size of the LED panel 110 may be the same as a total sum of a sum of actual sizes of the LED modules 112, 114, 116 and 118 and a sum of arrangement intervals, may be input as a horizontal size and a vertical size, and may be input in a unit of centimeter, but the present invention is not limited thereto. Also, when receiving the horizontal size of the LED panel 110, the data conversion module 134 may calculate and display the vertical size of the LED panel 110 by taking into consideration the ratio of the vertical size to the horizontal size in each corresponding frame image.

Also, the size of each LED module 112, 114, 116 and 118 corresponds to the size of each actual LED module constituting the LED panel 110, and may vary depending on the size of actually implemented LED modules.

Also, the arrangement direction may be received through “Left-Right” for arrangement from left to right, “Top-Down” for arrangement from top to bottom, “Cost-Effective” for arrangement to minimize an interval between LED modules, etc., as shown in FIG. 4A.

Also, the region rate may be received as an occupancy rate “Mask Filling” having a value within a range between 50% and 100%. When receiving a region rate of 100%, the data conversion module 134 arranges the LED modules 112, 114, 116 and 118 without any overlapped portion between the LED modules 112, 114, 116 and 118.

FIG. 4B is a view illustrating a frame image according to an exemplary embodiment of the present invention.

For example, when a moving picture that a word of “Rhinox” is moving in the form of a wave is converted to generate images according to frames, a frame image representing the word of “Rhinox” as shown in FIG. 4B is generated as one of frame images.

FIG. 4C is a view illustrating a state in which LED modules are arranged for each frame image according to an exemplary embodiment of the present invention.

When the size of the LED panel 110, the size of each LED module 112, 114, 116 and 118, an arrangement direction, a region rate, etc., as shown in FIG. 4A, are input for each frame image shown in FIG. 4B, and the LED modules 112, 114, 116 and 118 are arranged for each frame image, a resultant arrangement is output as shown in FIG. 4B.

As shown in FIG. 4C, a frame image shown in FIG. 4B is enlarged to the size of the LED panel 110 so as to be an image expressing the word of “Rhinox,” and each LED module 112, 114, 116 and 118 is attached to the word of “Rhinox,” so that the LED modules 112, 114, 116 and 118 have been arranged.

Also, through a portion below the word “Rhinox,” the horizontal size and vertical size of the LED panel 110 and the horizontal size and vertical size may be output, and also the arrangement direction, the region rate, etc. may be output.

Also, the size of a frame image before enlargement may be output in units of pixels, and in addition, the number of LED modules 112, 114, 116 and 118 which must be driven to output a moving image, the locations thereof, and the absolute locations thereof may be output, so that the user can exactly recognize the resultant arrangement.

After checking the resultant arrangement as shown in FIG. 4C, the user may rearrange each LED module 112, 114, 116 and 118, by clicking and dragging each module by means of a mouse, by moving each module by means of a separate working tool, or by newly inputting input values of FIG. 4A if necessary. That is, the size of the LED panel 110, the size of each LED module 112, 114, 116 and 118, an arrangement direction, a region rate, etc. may be newly input to rearrange the LED modules.

FIG. 4D is a view illustrating image data according to an exemplary embodiment of the present invention.

After checking the resultant arrangement through a screen as shown in FIG. 4C, the user selects a predetermined button output on the screen when determining the resultant arrangement as a final arrangement. Then, the data conversion module 134 determines the central point of each region assigned to each LED module 112, 114, 116 and 118 with respect to an enlarged frame image, generates color coordinates of each central point as image data by extracting the color coordinates from each central point, and outputs the image data, as shown in FIG. 4D.

Image data shown in FIG. 4D correspond to an example in which each LED module 112, 114, 116 and 118 is mapped to gradation obtained by quantizing color coordinates of red, green and blue with 8 bits. That is, since color coordinates have analog values for red, green and blue, in order to digitalize the color coordinates having analog values, the analog values of the color coordinates are matched to 256-level gradation which can represent 8-bit digital data, thereby being converted into data having values between 0 and 255.

Therefore, with respect to image data shown as an example in FIG. 4D, color coordinates of a region assigned to a first LED module 112 is converted into image data of Red 255, Green 255 and Blue 255, and color coordinates of a region assigned to a ninth LED module (not shown) is converted into image data of Red 0, Green 0 and Blue 0.

Such image data is transmitted from the data conversion apparatus 130 to the LED control apparatus 120.

When outputting a moving picture, the LED control apparatus 120 transits the image data to each LED module 112, 114, 116 and 118 according to a predetermined rule. Then, when outputting images according to each frame, each LED module 112, 114, 116 and 118 causes a red LED array, a green LED array and a blue LED array to emit each appointed color light by using color coordinates appointed by the image data, thereby outputting a moving picture.

Although an exemplary embodiment of the present invention has been described for illustrative purposes, those skilled in the art will appreciate that various modifications, additions and substitutions are possible, without departing from the scope and spirit of the invention as disclosed in the accompanying claims. Therefore, the embodiment disclosed in the present invention has been described not for limiting the scope of the invention, but for describing the invention. Accordingly, the scope of the invention is not to be limited by the above embodiment but by the claims and the equivalents thereof. It will be understood by those skilled in the art that various changes in form and details may be made therein without departing from the spirit and scope of the invention as defined by the appended claims.

### INDUSTRIAL APPLICABILITY

According to the present invention as described above, when a moving picture or a flash is output by means of LED modules, the moving picture or flash can be converted into image data so that a fine and smooth image just like an actual moving picture or flash can be output.

Through this, it is possible to output a moving picture or flash as a fine and smooth image by means of LED modules.

In addition, since LED modules to output a moving picture, a flash, etc. can be automatically arranged, it is possible to automate the arrangement procedure of the LED modules.

Also, since LED modules are arranged in consideration of the size of a LED panel, the size of each LED module, an arrangement direction, a region rate, etc, it is possible to optimize the arrangement of the LED modules.

In addition, since the user can manually rearrange automatically arranged LED modules, it is possible to adjust the arrangement of the LED modules according to necessity, and it is possible to reduce the number of required LED modules according to a resolution necessary for a moving picture or flash, so that it is possible to rapidly cope with a situation according to necessity.

1. An apparatus for converting a moving picture into image data in order to output the moving picture by means of a light emitting diode (LED) panel which includes a plurality of LED modules, the apparatus comprising:
a data storage module for storing the moving picture and the image data; and
a data conversion module for converting the moving picture into images according to frames, arranging the plurality of LED modules by matching the plurality of LED modules to the image according to each frame, determining locations of the plurality of LED modules, extracting color coordinates of each central point of regions in which the plurality of LED modules have been arranged from the image according to each frame, and generating color coordinates according to the locations as the image data.

2. The apparatus as claimed in claim 1, wherein the data conversion module generates an enlarged image according to each frame by converting a size of the image according to each frame into a predetermined size of the LED panel, divides the enlarged image according to each frame into division regions having predetermined sizes of the LED modules, and arranges the plurality of LED modules for the image according to each frame in such a manner as to correspond to the division regions respectively.

3. The apparatus as claimed in claim 2, wherein the data conversion module further comprises an input/output module for receiving and transmitting the size of the LED panel and the sizes of the LED modules to the data conversion module.

4. A method for converting a moving picture into image data in order to output the moving picture by means of a light emitting diode (LED) panel which includes a plurality of LED modules, the method comprising the steps of:
(a) converting the moving picture into images according to frames;
(b) arranging the plurality of LED modules by matching the plurality of LED modules to the image according to each frame, and determining locations of the plurality of LED modules;
(c) calculating each central point of regions in which the plurality of LED modules have been arranged for the image according to each frame; and
(d) extracting color coordinates of said each central point from the image according to each frame, and generating color coordinates according to the locations as the image data.

5. The method as claimed in claim 4, wherein step (b) comprises the steps of:
(b1) generating an enlarged image according to each frame by enlarging a size of the image according to each frame to a size of the LED panel including the plurality of LED modules;
(b2) dividing the enlarged image according to each frame into division regions having sizes equal to a sizes of the LED module;
(b3) arranging the plurality of LED modules in such a manner as to correspond to the division regions respectively; and
(b4) determining locations of the plurality of LED modules.

6. The method as claimed in claim 4, further comprising, after step (b), step (b5) of receiving a command to rearrange the plurality of LED modules and rearranging at least one of the LED modules for the images according to frames according to the command.

7. A method for arranging a plurality of LED modules for images according to frames in an apparatus which converts a moving picture into image data by converting the moving picture into the image according to each frame in order to output the moving picture by means of a light emitting diode (LED) panel including the LED modules, the method comprising the steps of:
(a) generating an enlarged image according to each frame by enlarging a size of the image according to each frame to a size of the LED panel;
(b) dividing the enlarged image according to each frame into division regions having sizes equal to sizes of the LED modules; and
(c) arranging the plurality of LED modules in such a manner as to correspond to the division regions respectively.

8. The method as claimed in claim 7, wherein, in step (c), the plurality of LED modules are arranged to correspond to the division regions according to one or more of a predetermined arrangement direction and a predetermined region rate under control of an LED controller.
